(19) United States
(12) Patent Application Publication
(10) Pub. No.: US 2018/0292662 A1
(43) Pub. Date: Oct. 11, 2018

(54) RECTANGULAR BEAM SHAPER HAVING MONOLITHIC BODY OF REFRACTIVE MATERIAL

(71) Applicant: OSELA INC., Lachine (CA)

(72) Inventor: Francis CAYER, Saint-Eustache (CA)

(21) Appl. No.: 15/819,039

(22) Filed: Nov. 21, 2017

Related U.S. Application Data
(60) Provisional application No. 62/481,903, filed on Apr. 5, 2017.

(51) Int. Cl. G02B 27/09

(52) U.S. Cl. CPC G02B 27/0927; G02B 27/095; G02B 27/0922

(57) ABSTRACT

The rectangular beam shaper can be used for formatting an incident optical beam along an optical path. The rectangular beam shaper generally has: a monolithic body of a refractive material having two opposite surfaces in the optical path, one of said opposite surfaces having a first acylindrical component fitting a first equation

$$z = \frac{{Cx}^{2}}{1 + {( 1 - ( 1 + K ) {C}^{2} {x}^{2} )}^{1 / 2}} + {f}_{1} ( x ) ,$$

in a Cartesian coordinate system (x,z), C being a first curvature constant, K being a first conic constant and f₁(x) being a first correction function, said first correction function being continuous; and one of said opposite surfaces having a second acylindrical component orthogonal to the first acylindrical component and fitting a second equation

$$z = \frac{{Dy}^{2}}{1 + {( 1 - ( 1 + L ) {D}^{2} {y}^{2} )}^{1 / 2}} + {f}_{2} ( y ) ,$$

in a Cartesian coordinate system (y,z); D being a second curvature constant, L being a second conic constant and f₂(x) being a second correction function, said second correction function being continuous.

### FIELD

The improvements generally relate to formatting an optical beam, and more particularly relate to formatting an optical beam having a predetermined intensity profile into an output optical beam having a rectangular intensity profile.

### BACKGROUND

U.S. Pat. No. 7,400,457 describes a beam shaping system for shaping an incident optical beam into an output optical beam having a rectangular intensity profile. Although existing beam shaping systems are satisfactory to a certain degree, there remains room for improvement.

### SUMMARY

It was found that such existing beam shaping system had drawbacks associated with its number of acylindrical lenses, and accordingly, its number of refractive index interfaces.

There is described a rectangular beam shaper for formatting an incident optical beam along an optical path. The rectangular beam shaper comprises a monolithic body of a refractive material having two opposite surfaces in the optical path. One of said opposite surfaces has a first acylindrical component and one of said opposite surfaces has a second acylindrical component orthogonal to the first acylindrical component. Accordingly, the rectangular beam shaper can be used to format an incident optical beam into an output optical beam having a rectangular intensity profile.

It was found that such a rectangular beam shaper can be advantageously used over the existing beam shaping system.

For instance, a given optical system having the monolithic body of refractive material can be less costly in terms of mounting equipment, footprint and bill of materials than an existing optical system having the beam shaping system with the two acylindrical lenses. Moreover, or alternatively, the optical alignment of the given optical system can be simplified due to the lesser number of manipulations required to align the monolithic body of refractive material than to align the two acylindrical lenses. Furthermore, a system having a lesser number of optical elements can be less likely to be misaligned by movements, impacts, vibrations, thermal variations and the like.

It is also emphasized that the given optical system can have a lesser number of refractive index changes or interfaces. Indeed, an optical beam propagating through the two separate acylindrical lenses will see four refractive index interfaces as opposed to two for an optical beam propagating through the monolithic body of refractive material. The lesser number of refractive index interfaces of the given optical system can thus reduce surface contamination risks. Moreover, the lesser number of refractive index interfaces of the given optical system can also reduce a total number of reflections occurring at each refractive index interface thus reducing the overall optical power loss. Further, it was also found that the likelihood of generating a parasitic signal inside the given optical system was reduced due to the fact that the monolithic body of refractive material lacks the two parallel flat surfaces, which have been found to act as a Fabry-Péerot interferometer in the existing optical system. In some embodiments, it was also found that reducing the number of refractive index interfaces of the given optical system can yield an output optical beam with less optical distortion.

In accordance with another aspect, there is provided a rectangular beam shaper for formatting an incident optical beam along an optical path, the rectangular beam shaper comprising: a monolithic body of a refractive material having two opposite surfaces in the optical path, one of said opposite surfaces having a first acylindrical component fitting a first equation

$$z = \frac{{Cx}^{2}}{1 + {( 1 - ( 1 + K ) {C}^{2} {x}^{2} )}^{1 / 2}} + {f}_{1} ( x ) ,$$

in a Cartesian coordinate system (x,z), C being a first curvature constant, K being a first conic constant and f₁(x) being a first correction function, said first correction function being continuous; and one of said opposite surfaces having a second acylindrical component orthogonal to the first acylindrical component and fitting a second equation

$$z = \frac{{Dy}^{2}}{1 + {( 1 - ( 1 + L ) {D}^{2} {y}^{2} )}^{1 / 2}} + {f}_{2} ( y ) ,$$

in a Cartesian coordinate system (y,z); D being a second curvature constant, L being a second conic constant and f₂(x) being a second correction function, said second correction function being continuous.

In one embodiment, a single one of the two opposite surfaces has the sum of both the first acylindrical component and the second acylindrical component.

In another embodiment, a first one of the two opposite surfaces has the first acylindrical component and a second one of the two opposite surfaces has the second acylindrical component.

In accordance with another aspect, there is provided an optical system comprising: a frame, an optical path positioned relative to the frame, an optical source mounted to the frame for emitting an incident optical beam along the optical path, a rectangular beam shaper mounted to the frame for formatting the incident optical beam along the optical path and providing an output optical beam, the rectangular beam shaper having a monolithic body of a refractive material having two opposite surfaces in the optical path, one of said opposite surfaces having a first acylindrical component fitting a first equation

$$z = \frac{{Cx}^{2}}{1 + {( 1 - ( 1 + K ) {C}^{2} {x}^{2} )}^{1 / 2}} + {f}_{1} ( x ) ,$$

in a Cartesian coordinate system (x,z), C being a first curvature constant, K being a first conic constant and f₁(x) being a first correction function, said first correction function being continuous; and one of said opposite surfaces having a second acylindrical component orthogonal to the first acylindrical component and fitting a second equation

$$z = \frac{{Dy}^{2}}{1 + {( 1 - ( 1 + L ) {D}^{2} {y}^{2} )}^{1 / 2}} + {f}_{2} ( y ) ,$$

in a Cartesian coordinate system (y,z); D being a second curvature constant, L being a second conic constant and f₂(x) being a second correction function, said second correction function being continuous.

Many further features and combinations thereof concerning the present improvements will appear to those skilled in the art following a reading of the instant disclosure.

### DESCRIPTION OF THE FIGURES

In the figures,

FIG. 1 is a perspective view of an example of a rectangular beam shaper having a monolithic, cylindrical body of refractive material with two opposite surfaces having a corresponding acylindrical component, in accordance with an embodiment;

FIG. 2 is a perspective view of an example of a rectangular beam shaper having a monolithic body of refractive material with two opposite surfaces having a corresponding acylindrical component, in accordance with an embodiment;

FIG. 3A is a graph showing an example of an intensity profile of an incident optical beam propagated through the rectangular beam shaper of FIG. 2, in accordance with an embodiment;

FIG. 3B is a graph showing an example of a rectangular intensity profile of an output optical beam propagated from the rectangular beam shaper of FIG. 2, in accordance with an embodiment;

FIG. 3C is a graph showing a section of the rectangular intensity profile taken along line 3C-3C of FIG. 3B, in accordance with an embodiment;

FIG. 3D is a graph showing a section of the rectangular intensity profile taken along line 3D-3D of FIG. 3B, in accordance with an embodiment;

FIG. 4 is a three-dimensional graph showing the rectangular intensity profile of FIG. 3B, in accordance with an embodiment;

FIG. 5 is a perspective view of an example of a rectangular beam shaper having a monolithic body of refractive material with a surface having two acylindrical components, in accordance with an embodiment;

FIG. 6A is a graph showing an example of an intensity profile of an incident optical beam propagated through the rectangular beam shaper of FIG. 5, in accordance with an embodiment;

FIG. 6B is a graph showing an example of a rectangular intensity profile of an output optical beam propagated from the rectangular beam shaper of FIG. 5, in accordance with an embodiment;

FIG. 6C is a graph showing a section of the rectangular intensity profile taken along line 6C-6C of FIG. 6B, in accordance with an embodiment;

FIG. 6D is a graph showing a section of the rectangular intensity profile taken along line 6D-6D of FIG. 6B, in accordance with an embodiment;

FIG. 7 is a three-dimensional graph showing the rectangular intensity profile of FIG. 6B, in accordance with an embodiment;

FIG. 8 is schematic view of an example of an optical system including an optical source, first optics, a monolithic body of refractive material, and second optics, in accordance with an embodiment;

FIG. 9 is a schematic view of an example of an optical system including a divergent optical source and a monolithic body of refractive material, in accordance with an embodiment; and

FIG. 10 is an oblique view of an example of a divergent optical source, in accordance with an embodiment.

### DETAILED DESCRIPTION

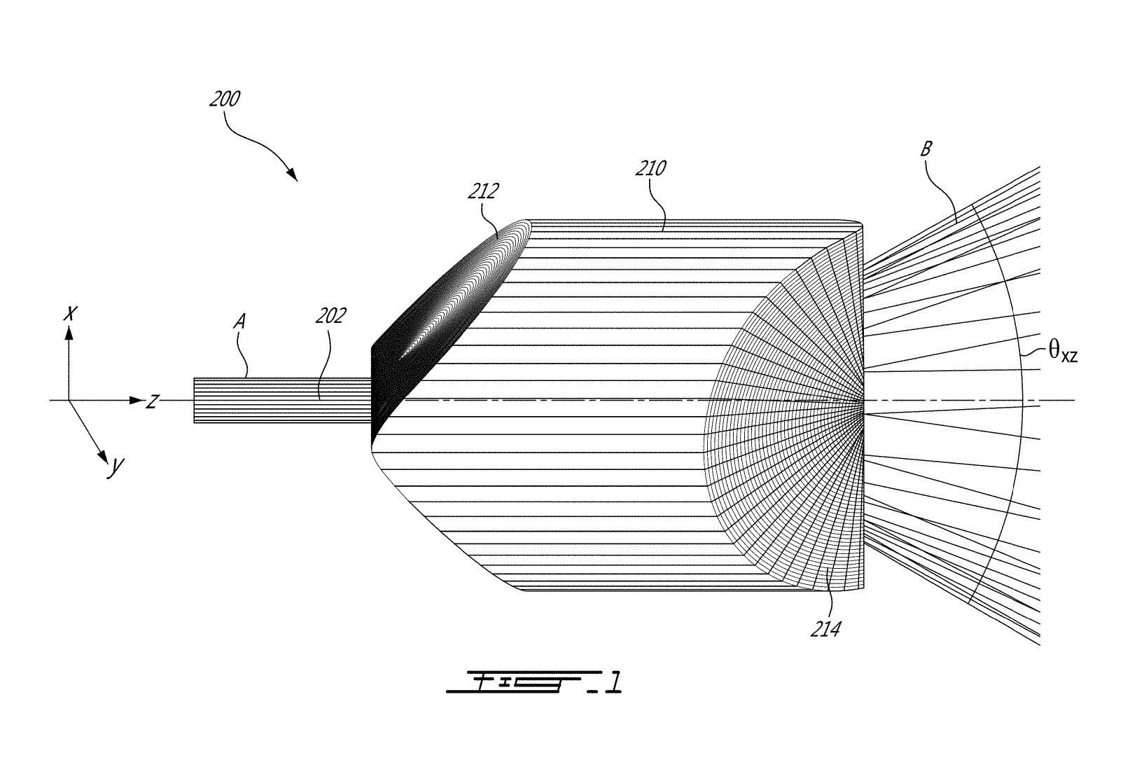

FIG. 1 shows an example of a rectangular beam shaper 200 for formatting an incident optical beam A along an optical path 202. For ease of reading, reference to the Cartesian coordinate system (x, y, z) will be made throughout this description. However, it will appear that any of the equations presented herein can also be expressed in other coordinate systems such as a spherical or cylindrical coordinate system. For instance, in this description, the z-axis is defined as being collinear to the optical path 202.

In this example, the incident optical beam A has an intensity profile which is Gaussian. More specifically, the given intensity profile of the incident optical beam A is given by equation (1):

$$I ( x , y ) = {e}^{{ }^{- {x}^{2}} \text{/} {σ}_{x}^{2}} + {e}^{{ }^{- {x}^{2}} \text{/} {σ}_{y}^{2}} , \qquad ( 1 )$$

wherein σₓ and σ_{y} are standard deviation constants. In alternate embodiments, the intensity profile of the incident optical beam can be any other suitable non-uniform intensity profile such as a profile with astigmatism, a super-Gaussian (under corrected) profile, a bi-modal or multimodal profile, or any non-rotationally symmetric and/or non-uniform profile.

In this embodiment, the incident optical beam A is collimated. However, in other embodiments, the incident optical beam can be divergent or convergent.

As illustrated, the rectangular beam shaper 200 has a monolithic body 210 of a refractive material having two opposite surfaces 212 and 214 in the optical path 202, wherein a first one of said opposite surfaces 212 and 214 (“the first surface 212”) has a first acylindrical component and a second one of the opposite surfaces 212 and 214 (“the second surface 212”) has a second acylindrical component orthogonal to the first acylindrical component. Accordingly, the resulting rectangular beam shaper 200 can be used to format the incident optical beam A into an output optical beam B having a rectangular intensity profile.

The first acylindrical component fits equation (2), in the Cartesian coordinate system (x,z), given by:

$$z = \frac{{Cx}^{2}}{1 + {( 1 - ( 1 + K ) {C}^{2} {x}^{2} )}^{1 / 2}} + {f}_{1} ( x ) , \qquad ( 2 )$$

wherein C is a first curvature constant, K is a first conic constant and f₁(x) is a first correction function which is continuous.

The second acylindrical component fits equation (3), in the Cartesian coordinate system (y, z), given by:

$$z = \frac{{Dy}^{2}}{1 + {( 1 - ( 1 + L ) {D}^{2} {y}^{2} )}^{1 / 2}} + {f}_{2} ( y ) , \qquad ( 3 )$$

wherein D is a second curvature constant, L is a second conic constant and f₂(x) is a second correction function which is continuous.

As can be understood, the radius of curvature is smaller in the center of the first and second surfaces, i.e. near the optical path 202, and increases towards edges of the monolithic body 210 which spreads out the incident optical beam A in the center while containing it on the edges. The optical intensity is thus spatially redistributed and, when the curvature and conic constants are suitably adapted to the intensity profile of the incident optical beam A, it can provide an output optical beam having a desired rectangular intensity profile. Since the rectangular beam shaper includes an acylindrical component for each of the orthogonal axes x and y, the two orthogonal axes x and y of the rectangular intensity profile are formatted independently from one another.

For instance, the rectangular intensity profile of the output optical beam B can be of the form:

$$J ( x , y ) = \frac{{e}^{- {( \frac{x}{{β}_{x}} )}^{n}} - {e}^{- {( \frac{y}{{β}_{y}} )}^{m}}}{{cos}^{p} ( x ) \cdot {cos}^{q} ( y )} , \qquad ( 4 )$$

wherein βₓ, β_{y}, n, m, p, and q are constants. As such, the intensity profile of the output optical beam B has a dimension Lₓ along the x-axis and a dimension Lₓ along the y-axis, wherein Lₓ depends on βₓ, n and p, and L_{y} depends on β_{y}, m and q. The intensity profile of the output optical beam can be varied between super-Gaussian, Gaussian and bi-modal by varying parameters n, m, p, and q. It is noted that some variations between the rectangular intensity profile given by equation (4) and the actual intensity profile of the output optical beam B can occur due to, for instance, imperfections of the intensity profile of the incident optical beam A and/or manufacturing errors.

As shown, the first and second surfaces 212 and 214 are both convex. However, in some other embodiments, the first surface 212 is convex and the second surface 214 is concave, or vice versa. In still other embodiments, both the first and second surfaces 212 and 214 are concave.

The convexity or concavity of the first surface 212 depends on the polarity of the first curvature constant C. For instance, the first surface 212 can be convex when the first curvature constant C has a first polarity, or concave when the first curvature constant C has a second polarity opposite to the first polarity.

Similarly, the convexity or concavity of the second surface 214 depends on the polarity of the second curvature constant D. For instance, the second surface 214 is convex when the second curvature constant D has a first polarity, or concave when the second curvature constant D has a second polarity opposite to the first polarity.

As shown in this example, the monolithic body 210 has a cylindrical shape axially extending along the optical path 202. The monolithic body can be made of glass with a refractive index lying between 1.4 and 2, but other optically transparent materials such as polycarbonate and silicones can be used in the alternative. In this embodiment, the monolithic body is made of BK7 glass by Schott™. The environment of the monolithic body 210 is air in this embodiment. Accordingly, so the incident optical beam A and the output optical beam B propagate in a refractive index of 1.

It will be noted that, in some embodiments, the first and second acylindrical components are perfectly orthogonal to one another. However, in some other embodiments, the first and second acylindrical components can be orthogonal to one another but not necessarily perfectly orthogonal to one another.

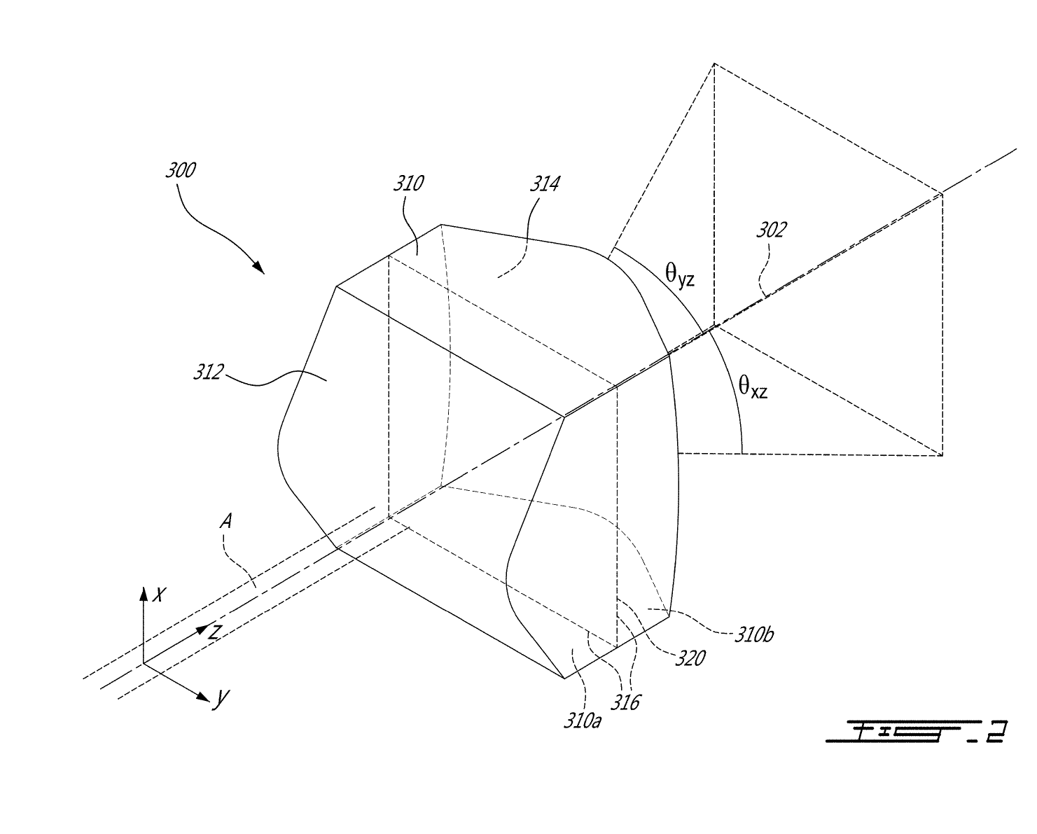

FIG. 2 shows another example of a rectangular beam shaper 300. As depicted, in this example, the rectangular beam shaper 300 has a monolithic body 310 of a refractive material having first and second opposite surfaces 312 and 314 in an optical path 302. Also in this example, the first surface 312 has a first acylindrical component according to the equation (2) above and the second surface 314 has a second acylindrical component according to the equation (3) above. Therefore, the resulting rectangular beam shaper 300 can also be used to format the incident optical beam A into an output optical beam B having a rectangular intensity profile.

As shown, the output optical beam B has a divergence angle θ_{xz} in the (x,z) plane and a divergence angle θ_{yz} in the (y,z) plane. More specifically, the divergence angle θ_{xz} depends on the first conic constant K and the divergence angle θ_{yz} depends on the second conic constant L. The divergence angles θ_{xz} and θ_{yz} may also depend on the first and second correction functions f₁(x) and f₂(y). In this example, both the first and second conic constants K and L are of a given polarity.

In contrast with the monolithic body 210 of FIG. 1, the monolithic body 310 has a rectangular shape extending along the optical path 302, between the first surface 312 and the second surface 314.

In this example, the monolithic body 310 is made of N-SF6 glass by Schott™, the first acylindrical component has a first curvature constant C of 1096 m⁻¹ and a first conic constant K of −3.544, the second acylindrical component has a second curvature constant D of −755 m⁻¹ and a second conic constant L of −3.747, the distance between the first and second surfaces 312 and 314 is 6.2 mm. In this specific embodiment, the first correction function f₁(x) is given by A_{2,x}·x² wherein the coefficient A_{2,x}=−0.024 and the second correction function f₂(y) is given by A_{2,y}·y² wherein the coefficient A_{2,y}=0.006478. However, in other embodiments, the first correction function f₁(x) can be given by Σᵢ₌₁^{∞}A_{i,x}·xⁱ wherein A_{i,x} includes a coefficient for each integer i and the second correction function f₂(x) can be given by Σᵢ₌₁^{∞}A_{i,y}·yⁱ wherein A_{i,y} includes a coefficient for each integer i.

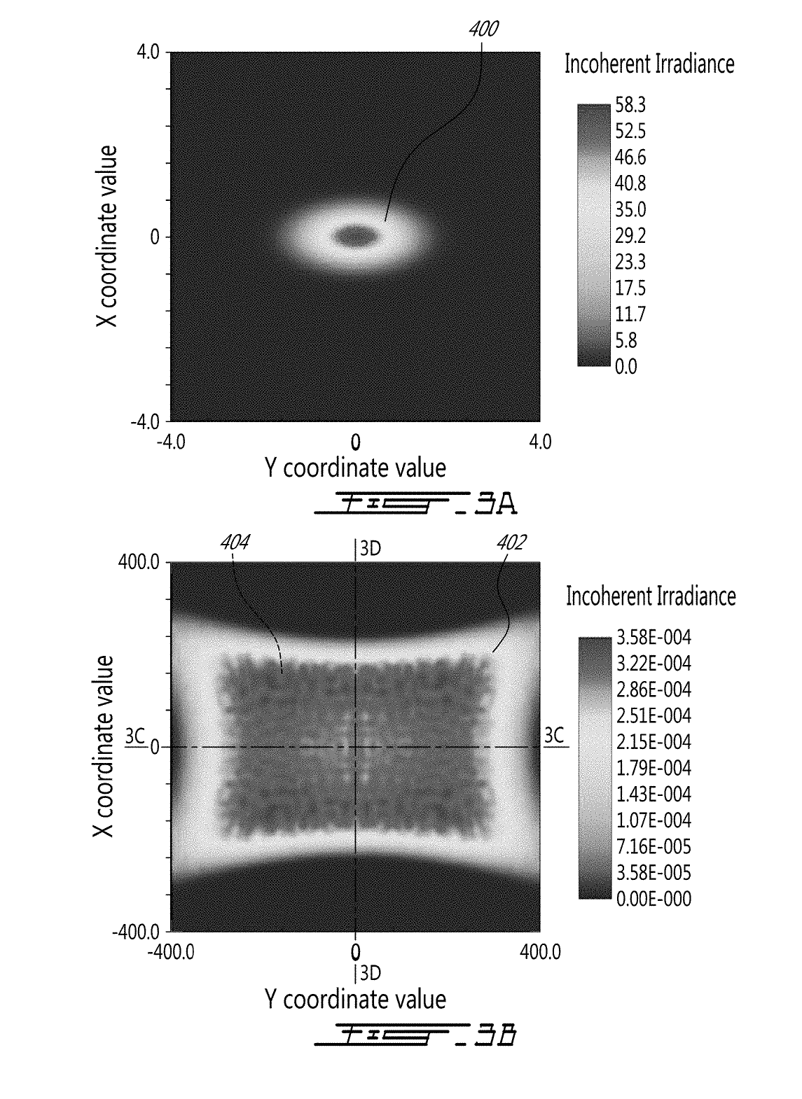

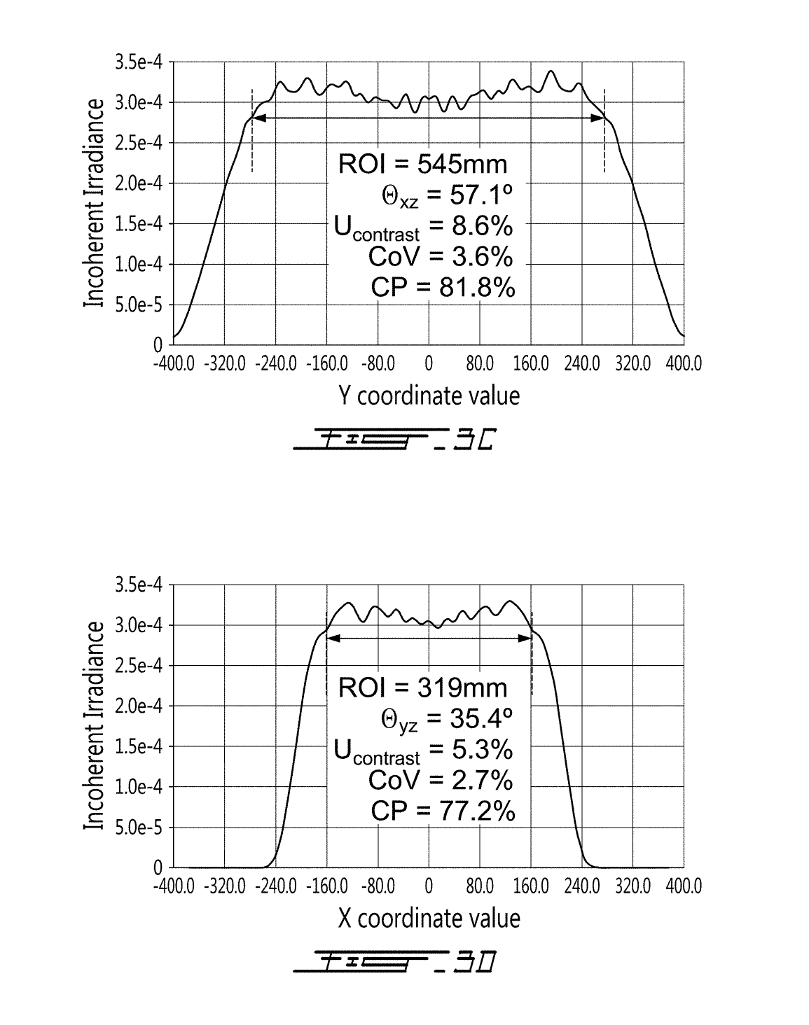

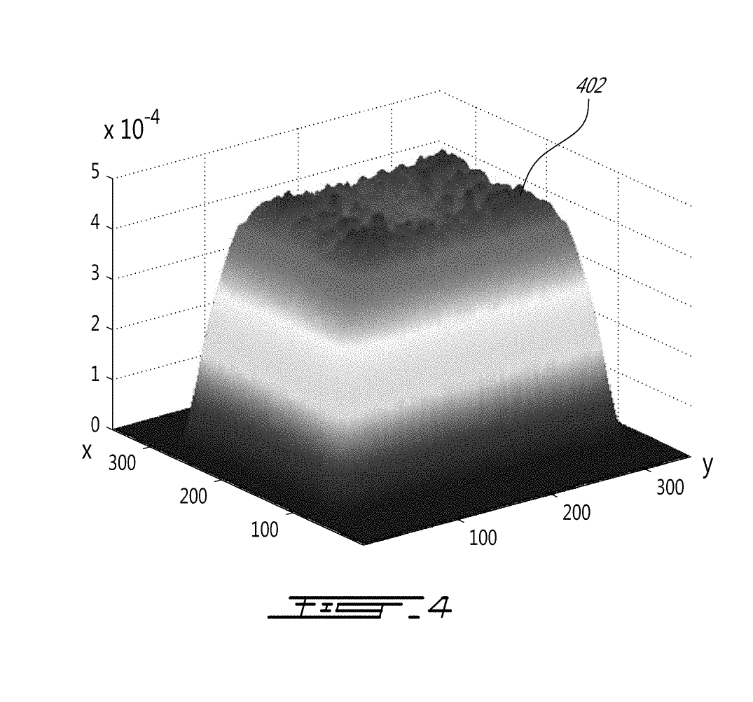

FIGS. 3A-D show the result of an exemplary computer simulation in which an incident optical beam A is propagated along the optical path 302 and through the rectangular beam shaper 300 of FIG. 2. In this example, the incident optical beam A has an elliptic intensity profile and is collimated with a collimated beam size (1/ê2) of 1.8 mm in x-axis and 4 mm in the y-axis, the Reference will thus be made to FIG. 2 in the description of this computer simulation.

More specifically, FIG. 3A is a graph showing an intensity profile 400 of the incident optical beam A. In this example, the intensity profile 400 of the incident optical beam A is elliptic. FIG. 3B is a graph showing a rectangular intensity profile 402 of the output optical beam B. Area 404 in the rectangular intensity profile 402 is where the optical energy of the output optical beam is mostly distributed, as shown in FIGS. 3C and 3D. FIG. 3C shows a graph of the rectangular intensity profile 402 taken along line 3C-3C of FIG. 3B. As shown in this graph, the region of interest (ROI) has 545 mm along the y-axis, the divergence angle θ_{yz} is 57.1°, the Ucontrast is 8.6%, the CoV is 3.6%, and the CP is 81.8%. FIG. 3D shows a graph of the rectangular intensity profile 402 taken along line 3D-3D of FIG. 3B. As depicted in this graph, the ROI has 319 mm along the x-axis, the divergence angle θ_{xz} is 35.4°, the Ucontrast is 5.3%, the CoV is 2.7%, and the CP is 77.2%. FIG. 4 is a three-dimensional graph showing the rectangular intensity profile 402 of FIG. 3B.

Referring back to FIG. 2, the monolithic body 310 has two parts 310a and 310b adjoined to one another. For instance, the part 310a has the first surface 312 and an opposite surface 316 whereas the part 310b has the second surface 314 and an opposite surface 316. In this example, the surfaces 316 are adjoined to one another. In some embodiments, the surfaces 316 can be adhered to one another using optical adhesive 320 having a refractive index corresponding to the refractive index of the two parts 310a and 310b to avoid an additional refractive index interface. In some other embodiments, the surfaces 316 can be fused together using high pressure and temperature process. In alternate embodiments, the surfaces 316 are adjoined to one another using optical contact bonding.

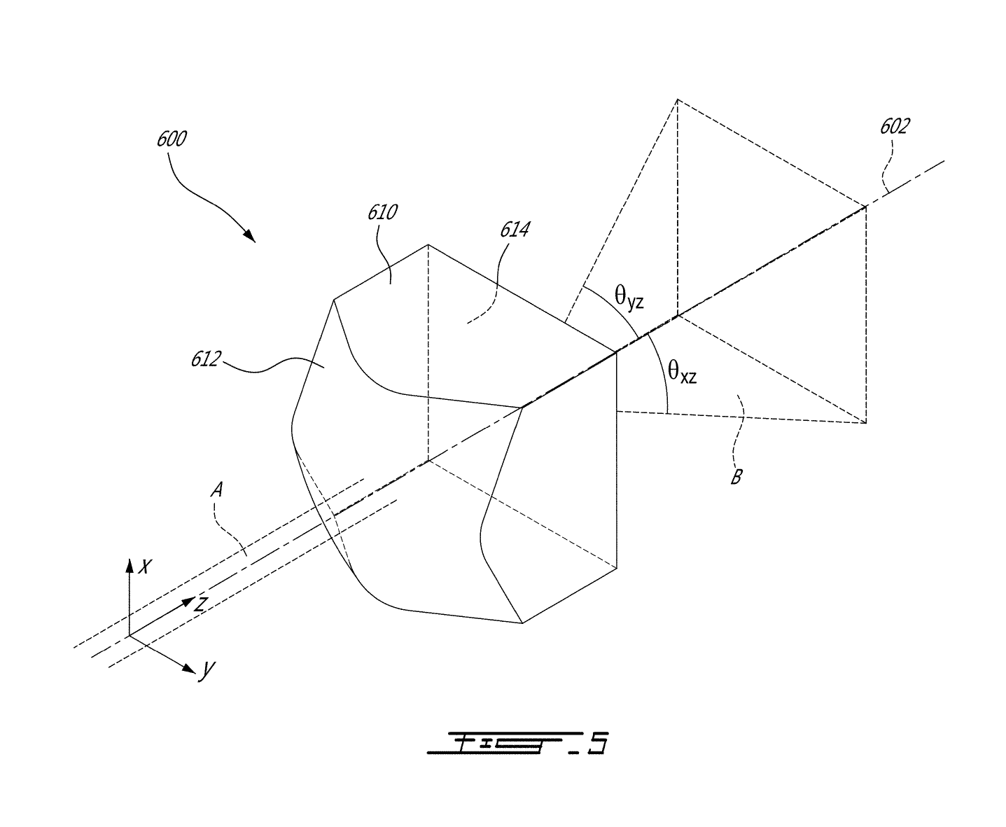

FIG. 5 shows another example of a rectangular beam shaper 600. As depicted, in this example, the rectangular beam shaper 600 has a monolithic body 610 of a refractive material having first and second opposite surfaces 612 and 614 in an optical path 602. In this specific example, a first one of said opposite surfaces 612 and 614 (“the first surface 612”) has both a first acylindrical component according to the equation (2) above and a second acylindrical component orthogonal to the first acylindrical component according to the equation (3) above. In this example, a second one of said opposite surfaces 612 and 614 (the second surface 614″) is planar. Therefore, the resulting rectangular beam shaper 600 can also be used to format the incident optical beam A into an output optical beam B having a rectangular intensity profile.

In this case, the first surface 612 fits equation (5) resulting from the sum of the equations (2) and (3). Accordingly, the equation (5), in the Cartesian coordinate system, can be given by:

$$z = \frac{{Cx}^{2}}{1 + {( 1 - ( 1 + K ) {C}^{2} {x}^{2} )}^{1 / 2}} + \frac{{Dy}^{2}}{1 + {( 1 - ( 1 + L ) {D}^{2} {y}^{2} )}^{1 / 2}} + {f}_{1} ( x ) + {f}_{2} ( y ) , \qquad ( 5 )$$

Also in this example, the monolithic body 610 has a rectangular shape extending along the optical path 602, between the first surface 612 and the second surface 614.

In this example, the monolithic body 610 is made of N-SF6 glass by Schott™, the first acylindrical component has a first curvature constant C of 1096 m⁻¹ and a first conic constant K of −3.544, the second acylindrical component has a second curvature constant D of 762 m⁻¹ and a second conic constant L of −2.404, the distance between the first and second surfaces 612 and 614 is 6.2 mm. In this specific embodiment, the first correction function f₁(x) is given by A_{2,x}·x² wherein the coefficient A_{2,x}=−0.024 and the second correction function f₂ (y) is given by A_{2,y}·y² wherein the coefficient A_{2,y}=−0.015.

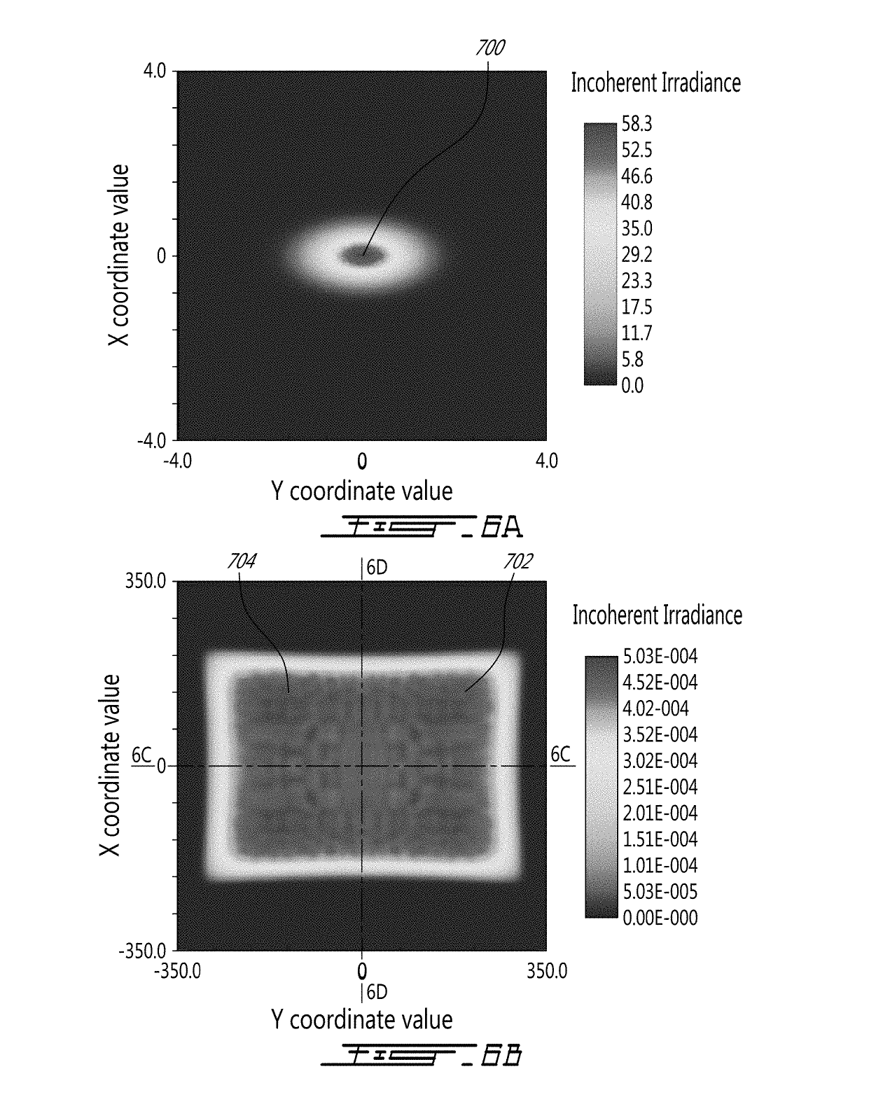

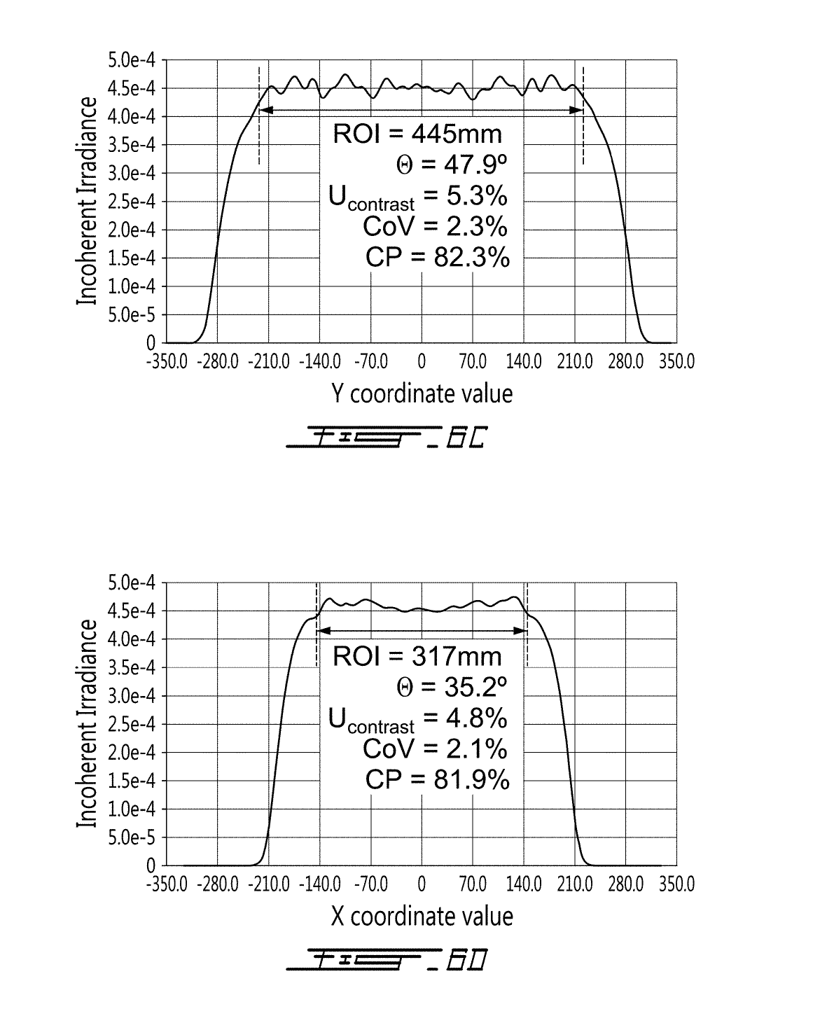

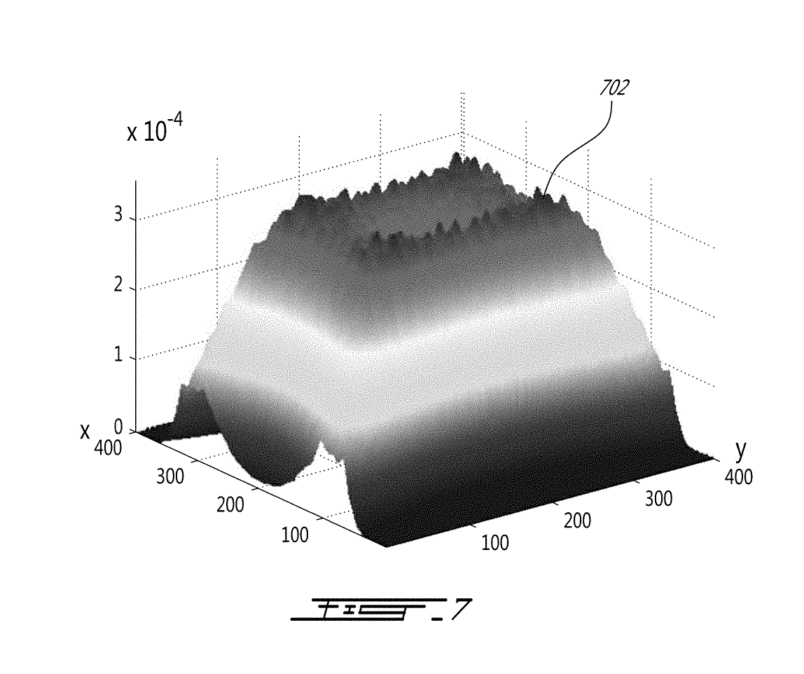

FIGS. 6A-D show the result of an exemplary computer simulation in which an incident optical beam A is propagated along the optical path 602 and through the rectangular beam shaper 600 of FIG. 5. In this example, the incident optical beam A has an elliptic intensity profile and is collimated with a collimated beam size (1/ê2) of 1.5 mm in x-axis and 3 mm in the y-axis. Reference will thus be made to FIG. 5 in the description of this computer simulation.

More specifically, FIG. 6A is a graph showing an intensity profile 700 of the incident optical beam A. In this example, the intensity profile 700 of the incident optical beam A is elliptic. FIG. 6B is a graph showing a rectangular intensity profile 702 of the output optical beam B. Area 704 in the rectangular intensity profile 702 is where the optical energy of the output optical beam is mostly distributed, as shown in FIGS. 6C and 6D. FIG. 6C shows a graph of the rectangular intensity profile 702 taken along line 6C-6C of FIG. 6B. As shown in this graph, the ROI along the y-axis is 445 mm, the divergence angle θ_{yz} is 47.9°, the Ucontrast is 5.3%, the CoV is 2.3%, and the CP is 82.3%. FIG. 6D shows a graph of the rectangular intensity profile 702 taken along line 6D-6D of FIG. 6B. As depicted in this graph, the ROI along the x-axis is 317 mm, the divergence angle θ_{xz} is 35.2°, the Ucontrast is 4.8%, the CoV is 2.1%, and the CP is 81.9%. FIG. 7 is a three-dimensional graph showing the rectangular intensity profile 702 of FIG. 6B.

As can be seen by comparing the rectangular intensity profiles 402 of FIG. 3B and 702 of FIG. 6B with one another, one may device to provide the first and second acylindrical components to a same surface of the monolithic body, as in the rectangular beam shaper 600, to provide an output optical beam having a rectangular intensity profile having a reduced amount of distortion.

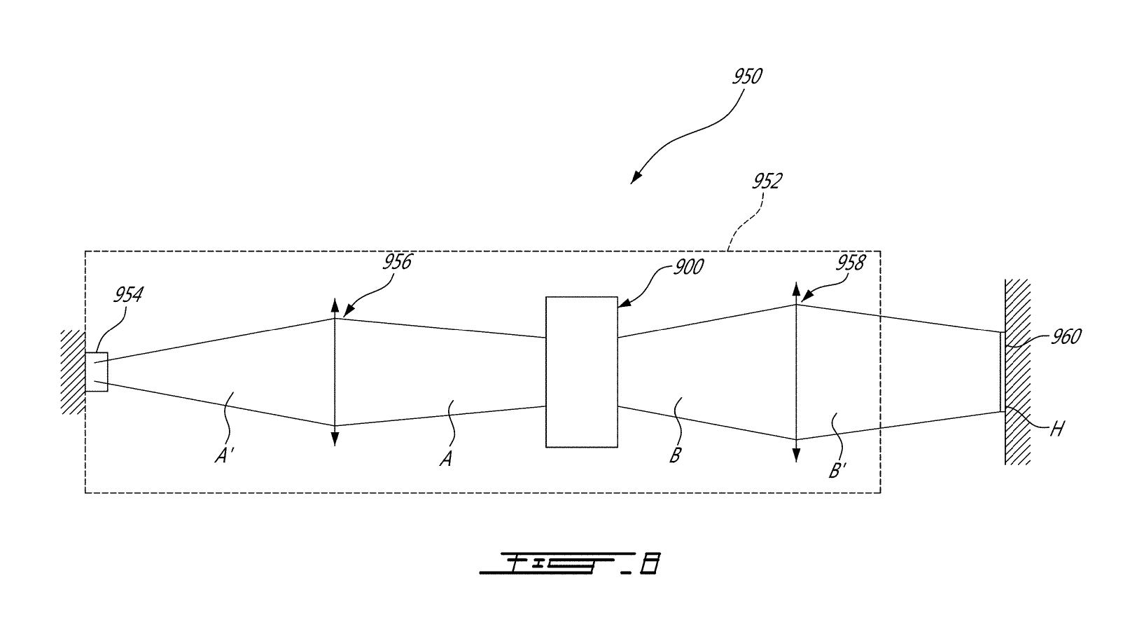

FIG. 8 is an example of an optical system 950 including a rectangular beam shaper 900 having a monolithic body of refractive material. As depicted, in this example, the optical system 950 has a frame 952. In some embodiments, the frame 952 can be provided in the form of an enclosure having an appropriate window. The frame 952 can be provided in the form of an optical table in some other embodiments. The optical system 950 has an optical source 954 mounted to the frame 952 for emitting an optical beam A′, first optics 956 for receiving the emitted optical beam A′ from the optical source 954 and projecting it into the form of an incident optical beam A, the rectangular beam shaper 900 for receiving the incident optical beam A and formatting it into the output optical beam B having a rectangular intensity profile, and second optics 958 for receiving the output optical beam B and projecting it into the form of a projected output optical beam B′. In this example, the first and second optics 956 and 958 are mounted to the frame 952 via mounts. In this example, the optical beam A′ emitted from the optical source 954 is divergent. Accordingly, the first optics 956 are provided in the form of collimating optics to collimate the emitted optical beam A′ into the incident optical beam A. In other embodiments, the first optics 956 can be used to expand or contract the incident optical beam A to desired dimensions. As shown, in this example, the rectangular beam shaper 900 is divergent. Accordingly, the second optics 958 are provided in the form of focusing optics to focus the output optical beam B onto a plane H, where the rectangular intensity profile of the projected output optical beam B′ can be appreciated. In some other embodiments, the projected output optical beam B′ is focussed on a rectangular target 960 (e.g., a rectangular sensor) with the rectangular intensity profile at the Fourier plane of the rectangular target 960. In other embodiments, the second optics 958 can be used to expand or contract the output optical beam B to desired dimensions or to image the output optical beam B. In alternate embodiments, the second optics 958 can be provided in the form of a diffractive beam splitter, a refractive beam splitter and/or a micro lenses array to provide multiple rectangular flat-top pattern arranged in row(s) or an array. Alternatively or additionally, the first and second optics 956 and 958 can include cylindrical lens(es), spherical lens(es) and/or any other suitable optical elements.

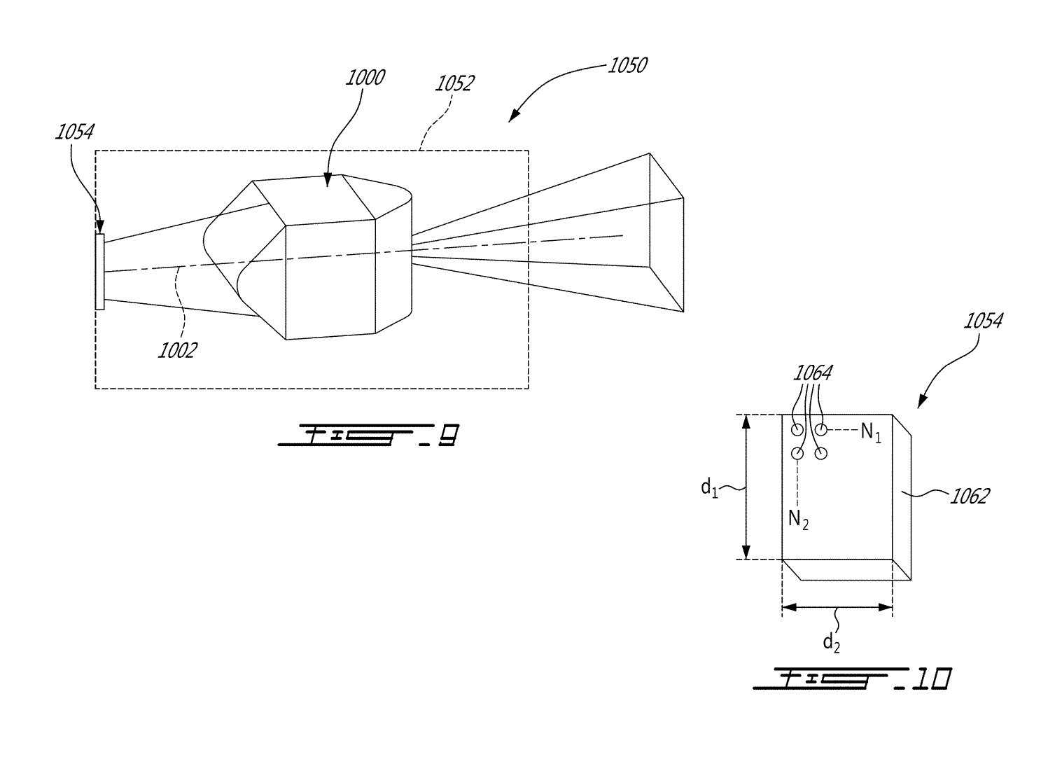

The first and second optics can be omitted in other embodiments. For instance, FIG. 9 shows an optical system 1050 including a rectangular beam shaper 1000 having a monolithic body of refractive material. As shown, the optical system 1050 has a frame 1052 to which is mounted the rectangular beam shaper 1000. In this example, the optical system 1050 has an optical source 1054 which is mounted to the frame 1052 for emitting an incident optical beam along an optical path 1002. In this way, the rectangular beam shaper 1000 receives the incident optical beam and formats it in into the output optical beam, which has a rectangular intensity profile. In this specific embodiment, the optical source 1054 is a divergent optical source 1054. As best shown in the example of FIG. 10, the divergent optical source 1054 includes an array 1062 of vertical-cavity surface-emitting laser (VECSEL) emitters 1064. As depicted, the array 1062 has a rectangular shape having first and second dimensions d₁ and d₂. In this example, the first and second dimensions d₁ and d₂ are both equal to 1 mm and the array 1062 has an area of 1 mm². As shown, the array 1062 includes N₁×N₂ VECSEL emitters 1064. For instance, the array 1062 can have 20×20 VECSEL emitters 1064, 25×25 VECSEL emitters 1064 or any other suitable number of VECSEL emitters.

As can be understood, the examples described above and illustrated are intended to be exemplary only. For example, the first and second acylindrical components can be designed such that the rectangular intensity profile of the output beam can differ between the x-axis and the y-axis. Different combinations of intensity profile in the x- and y-axes are possible. In some embodiments, the rectangular intensity profile can have a flat-top intensity profile in the x-axis and a cosine corrected intensity profile in the y-axis. For instance, it is noted that the incident optical beam can be single-mode or multi-mode and that its wavelength can range between about 275 nm and 1600 μm. The incident optical beam can be emitted from a light source such as a laser diode, one or more light-emitting diodes (LEDs), one or more VECSEL emitter, a fiber laser source, an argon laser source, an excimer laser source, a tunable laser source or any other suitable light source. For example, the light source can be a laser diode source providing an incident laser beam of 100 mW of power with a wavelength of 660 nm, used in pair with an aspheric collimator with a focal length of 4.5 mm. In some embodiments, illumination of a target with the output optical beam requires two or more wavelengths. In these embodiments, the two or more wavelengths can be provided by combining two or more incident optical beams together and by providing the combined incident beam to the rectangular beam shaper. In these embodiments, the rectangular beam shaper has a low wavelength dependency so that it can be adapted to format the intensity profile of the various wavelengths of the combined incident beam into a rectangular intensity profile. The scope is indicated by the appended claims.

What is claimed is:

1. A rectangular beam shaper for formatting an incident optical beam along an optical path, the rectangular beam shaper comprising: a monolithic body of a refractive material having two opposite surfaces in the optical path, one of said opposite surfaces having a first acylindrical component fitting a first equation
$$z = \frac{{Cx}^{2}}{1 + {( 1 - ( 1 + K ) {C}^{2} {x}^{2} )}^{1 / 2}} + {f}_{1} ( x ) ,$$
in a Cartesian coordinate system (x,z), C being a first curvature constant, K being a first conic constant and f₁(x) being a first correction function, said first correction function being continuous; and one of said opposite surfaces having a second acylindrical component orthogonal to the first acylindrical component and fitting a second equation
$$z = \frac{{Dy}^{2}}{1 + {( 1 - ( 1 + L ) {D}^{2} {y}^{2} )}^{1 / 2}} + {f}_{2} ( y ) ,$$
in a Cartesian coordinate system (y,z); D being a second curvature constant, L being a second conic constant and f₂(x) being a second correction function, said second correction function being continuous.

2. The rectangular beam shaper of claim 1 wherein a first one of the two opposite surfaces has the sum of both the first acylindrical component and the second acylindrical component.

3. The rectangular beam shaper of claim 2 wherein the first one of the two opposite surfaces is convex.

4. The rectangular beam shaper of claim 1 wherein a first one of the two opposite surfaces has the first acylindrical component and a second one of the two opposite surfaces has the second acylindrical component.

5. The rectangular beam shaper of claim 4 wherein the two opposite surfaces are convex.

6. The rectangular beam shaper of claim 4 wherein the monolithic body includes a first part having the first one of the two opposite surfaces and another surface, and a second part having the second one of the two opposite surfaces and another surface, the other surface of the first part being adjoined to the other surface of the second part.

7. The rectangular beam shaper of claim 6 wherein the other surface of the first part is adhered to the other surface of the second part via an optical adhesive having a refractive index corresponding to a refractive index of the first and second parts of the monolithic body.

8. An optical system comprising: a frame, an optical path positioned relative to the frame, an optical source mounted to the frame for emitting an incident optical beam along the optical path, a rectangular beam shaper mounted to the frame for formatting the incident optical beam along the optical path and providing an output optical beam, the rectangular beam shaper having a monolithic body of a refractive material having two opposite surfaces in the optical path, one of said opposite surfaces having a first acylindrical component fitting a first equation
$$z = \frac{{Cx}^{2}}{1 + {( 1 - ( 1 + K ) {C}^{2} {x}^{2} )}^{1 / 2}} + {f}_{1} ( x ) ,$$
in a Cartesian coordinate system (x,z), C being a first curvature constant, K being a first conic constant and f₁(x) being a first correction function, said first correction function being continuous; and one of said opposite surfaces having a second acylindrical component orthogonal to the first acylindrical component and fitting a second equation
$$z = \frac{{Dy}^{2}}{1 + {( 1 - ( 1 + L ) {D}^{2} {y}^{2} )}^{1 / 2}} + {f}_{2} ( y ) ,$$
in a Cartesian coordinate system (y,z); D being a second curvature constant, L being a second conic constant and f₂(x) being a second correction function, said second correction function being continuous.

9. The optical system of claim 8 wherein the optical source is a divergent optical source.

10. The optical system of claim 9 wherein the divergent optical source includes an array of vertical-cavity surface-emitting laser emitters.

11. The optical system of claim 8 further comprising first optics mounted to the frame for receiving the incident optical beam and formatting the incident optical beam along the optical path.

12. The optical system of claim 8 further comprising second optics mounted to the frame for receiving the output optical beam and projecting it onto a rectangular target, the output optical beam having a rectangular intensity profile illuminating the rectangular target.

13. The optical system of claim 8 wherein a first one of the two opposite surfaces has the sum of both the first acylindrical component and the second acylindrical component.

14. The optical system of claim 13 wherein the first one of the two opposite surfaces is convex.

15. The optical system of claim 8 wherein a first one of the two opposite surfaces has the first acylindrical component and a second one of the two opposite surfaces has the second acylindrical component.

16. The optical system of claim 15 wherein the two opposite surfaces are convex.

17. The optical system of claim 15 wherein the monolithic body includes a first part having the first one of the two opposite surfaces and another surface, and a second part having the second one of the two opposite surfaces and another surface, the other surface of the first part being adjoined to the other surface of the second part.

18. The optical system of claim 17 wherein the other surface of the first part is adhered to the other surface of the second part via an optical adhesive having a refractive index corresponding to a refractive index of the first and second parts of the monolithic body.
